(19) United States
(12) Patent Application Publication
(10) Pub. No.: US 2021/0017053 A1
(43) Pub. Date: Jan. 21, 2021

(54) METHOD FOR REMOVING HEAVY METAL FROM WATER BODY

(71) Applicant: SUN YAT-SEN UNIVERSITY, Guangzhou (CN)

(72) Inventors: Jingyun Fang, Guangzhou (CN); Kaiheng Guo, Guangzhou (CN); Xinwen Kang, Guangzhou (CN); Wenrui Wei, Guangzhou (CN)

(73) Assignee: SUN YAT-SEN UNIVERSITY, Guangzhou (CN)

(21) Appl. No.: 16/855,099

(22) Filed: Apr. 22, 2020

(30) Foreign Application Priority Data
Jul. 18, 2019 (CN) 201910649648.4

(51) Int. Cl. C02F 1/62; C02F 1/28; C02F 1/32; C02F 1/68; C02F 1/72; C02F 1/66

(52) U.S. Cl. CPC C02F 1/62; C02F 1/281; C02F 1/32; C02F 2101/20; C02F 1/72; C02F 1/66; C02F 1/68

(57) ABSTRACT

The present invention provides a method for removing a heavy metal from a water body, including the following steps: mixing a soluble permanganate with a water body containing heavy metal, and performing an oxidation-adsorption reaction under a light irradiation condition. The present invention does not require additional addition of other catalysts, but utilizes light to photo-decompose the permanganate to produce an active manganese substance (for example, Mn (V) and Mn (III)), a hydroxyl radical (.OH), and a stable colloidal manganese oxide having rich surface hydroxyl groups and a large specific surface area. These active substances can promote the release of an organic heavy metal into an inorganic heavy metal ion by oxidation; they can also promote the adsorption of the colloidal manganese oxide on the inorganic heavy metal ion; thus, the inorganic heavy metal and the organic heavy metal are removed from the water body.

### CROSS REFERENCE TO RELATED APPLICATION

This application claims the benefit of CN Patent Application No. 201910649648.4, which was filed Jul. 18, 2019 and is incorporated herein by reference as if fully set forth.

### TECHNICAL FIELD

The present invention belongs to the technical field of water treatment, and particularly relates to a method for removing a heavy metal from a water body.

### BACKGROUND

With the rapid development of social economy and the acceleration of urbanization, the problem of heavy metal pollution in water bodies has become more and more serious. Heavy metal pollutants in the water environment mainly come from wastewater discharged directly or indirectly from industries such as mining, batteries, fertilizers, electroplating, tanning, papermaking and pesticides. Common forms of heavy metals include inorganic forms and organic forms, such as residual form, iron-manganese bound form and carbonate bound form. Common inorganic heavy metal elements include copper (Cu), cobalt (Co), cadmium (Cd), lead (Pb), arsenic (As), thallium (Tl), zinc (Zn), chromium (Cr), selenium (Se), and tin (Sn), etc. Common organic heavy metal substances include alkyl mercury, alkyl tin, and copper ethylenediaminetetraacetate (Cu-EDTA), etc. Heavy metals can also participate in the formation of pesticides or antibiotics, such as roxarsone (ROX), a hardly degradable substance. As heavy metals are non-degradable, persistent and accumulative, the control of water body heavy metal pollution has become a global environmental problem. Heavy metals can not only deteriorate water quality and threaten the survival of aquatic organisms, but also pass through bio-concentration and food chain, thereby ultimately endangering human health.

At present, commonly used methods for removing inorganic heavy metals include coagulation precipitation method, chemical precipitation method, redox method, ion exchange method, membrane separation method, biological method and adsorption method, etc., all of which have certain defects, for example, the types and valence state of heavy metals to be removed are limited, and the removal efficiency is low; besides, the traditional water treatment process is difficult to remove heavy metal organic pollutants, even if organic groups are destroyed by a strong oxidant, the steps of adsorption, flocculation cannot be simultaneously achieved, and some organic matters containing heavy metals are difficult to remove.

As a strong oxidant, permanganate is widely used in pre-oxidation or oxidation process in water treatment. The advantages of permanganate are its easy and safe storage and delivery, and low cost. As a green oxidant, permanganate does not produce toxic and harmful by-products in the oxidation of organic heavy metals, and manganese dioxide produced during the oxidation can adsorb heavy metals in the environment. However, the oxidation capability of the permanganate is limited, so it is less effective with respect to some organic heavy metal pollutants and structurally stable organic substances containing heavy metals; the decomposition products of organic matters containing heavy metals cannot be treated, and the threat of heavy metals to a water body cannot be fundamentally removed.

### SUMMARY

In view of the above, an objective of the present invention is to provide a method for removing a heavy metal from a water body, and the method provided by the present invention can effectively remove an inorganic heavy metal and an organic heavy metal from the water body.

To achieve the above purpose, the present invention provides the following technical solutions.

The present invention provides a method for removing a heavy metal from a water body, including the following steps:

mixing a soluble permanganate with a water body containing heavy metal, and performing an oxidation-adsorption reaction under a light irradiation condition.

Preferably, the soluble permanganate is potassium permanganate and/or sodium permanganate, and the concentration of the soluble permanganate in the water body is 5-1,000 μmol/L.

Preferably, the form of the heavy metal in the water body includes an inorganic form and/or an organic state; the inorganic form includes an inorganic salt including one or more of copper, cobalt, cadmium, lead, arsenic, thallium, zinc, chromium, selenium and tin; the organic form includes an organic matter including one or more of copper, cobalt, cadmium, lead, arsenic, thallium, zinc, chromium, selenium and tin.

Preferably, a molar concentration ratio of the soluble permanganate to the heavy metal in the water body is (1-1,000):1.

Preferably, the wavelength of the light is ≤400 nm; the intensity of the light irradiation is 40-1,500 mJ·cm⁻².

Preferably, a light source of the light includes one or more of a light emitting diode, a low pressure mercury lamp, a medium pressure mercury lamp, a high pressure mercury lamp, an amalgam ultraviolet lamp, a halogen lamp, a xenon lamp, a black lamp, a vacuum ultraviolet lamp, an X-ray, an α-ray, and a Υ-ray.

Preferably, the manner of the light irradiation is over-current, immersed or surface irradiation.

Preferably, the temperature of the oxidation-adsorption reaction is 20-40° C., and the time is 10-60 min.

Preferably, an initial pH of the oxidation-adsorption reaction is 4-9.

Preferably, a reagent for adjusting the pH of the oxidation-adsorption reaction is one or more of nitric acid, hydrochloric acid, sulfuric acid and sodium hydroxide.

The present invention provides a method for removing a heavy metal from a water body, including the following steps: mixing a soluble permanganate with a water body containing heavy metal, and performing an oxidation-adsorption reaction under a light irradiation condition. The present invention does not require additional addition of other catalysts, but utilizes light to photo-decompose the permanganate to produce an active manganese substance (for example, Mn (V) and Mn (III)), a hydroxyl radical (.OH), and a stable colloidal manganese oxide having rich surface hydroxyl groups and a large specific surface area. These active substances can promote the release of an organic heavy metal into an inorganic heavy metal ion by oxidation; at the same time, they can also promote the adsorption of the colloidal manganese oxide on the inorganic heavy metal ion. Therefore, the technique removes the inorganic heavy metal and the organic heavy metal from the water body by the combined action of oxidation and adsorption.

Moreover, the method provided by the present invention has high removal efficiency, simple operation, low cost, and no secondary pollution, and can be applied to deep treatment of a water body including a heavy metal.

Further, in comparison with a conventional treatment method of a micro-pollutant in a water body, through the rational design of the process under the technical concept of the present invention, the present invention can not only decompose an organic pollutant including a heavy metal in the water body, but also adsorb and remove a heavy metal ion, thereby realizing the adsorption and removal of the heavy metal ion while solving the problem of decomposition of the organic matter including the heavy metal, and having significant environmental benefits.

Test results show that the method provided by the present invention can achieve a technical effect that the removal rate of inorganic heavy metals cadmium and copper in the water body is close to 100% at 60 min and 10 min respectively; the present invention can oxidize roxarsone (ROX) well to release inorganic arsenic from the ROX, and the removal rate of the ROX reaches 93.80-96.66% at 60 min.

### BRIEF DESCRIPTION OF THE DRAWINGS

FIG. 1 is a graph showing a change in a Cd concentration in a water body with time according to Embodiment 1 of the present invention;

FIG. 2 is a graph showing a change in a Cu concentration in a water body with time according to Embodiment 2 of the present invention;

FIG. 3 is a graph showing a change in a roxarsone (ROX) concentration in a water body with time according to Embodiment 3 of the present invention; and

FIG. 4 is a graph showing a change in a ROX concentration in a water body with time in a water body according to Embodiment 4 of the present invention.

### DETAILED DESCRIPTION

The present invention provides a method for removing a heavy metal from a water body, including the following steps:

mix a soluble permanganate with a water body containing heavy metal, and perform an oxidation-adsorption reaction under a light irradiation condition.

The present invention has no special limit on the soluble permanganate, and a soluble permanganate well known to those skilled in the art may be used. In the present invention, the soluble permanganate preferably includes potassium permanganate and/or sodium permanganate. The present invention has no special limit on the manner of use of the soluble permanganate, and specifically, the permanganate may be used directly in the form of solid powder or solution.

In the present invention, the concentration of the soluble permanganate in the water body is preferably 5-1,000 μmol/L, more preferably 50-800 μmol/L, and most preferably 100-500 μmol/L.

In the present invention, the water body preferably includes drinking water, surface water, ground water, domestic sewage or industrial wastewater. The present invention has no special limit on the specific source of the water body, and a source well known to those skilled in the art may be used.

In the present invention, the form of the heavy metal in the water body preferably includes an inorganic state and/or an organic state. In the present invention, the inorganic form preferably includes an inorganic salt including one or more of copper, cobalt, cadmium, lead, arsenic, thallium, zinc, chromium, selenium and tin, and more preferably includes an inorganic salt including one or more of copper, cobalt, cadmium, lead, arsenic, chromium and selenium. In the present invention, the organic form preferably includes a complex and/or an organic matter including one or more of copper, cobalt, cadmium, lead, arsenic, thallium, zinc, chromium, selenium and tin, and more preferably includes a complex and/or an organic matter including one or more of copper, cobalt, cadmium, lead, arsenic, chromium and selenium. In the present invention, the complex preferably includes a complexed heavy metal substance in a natural water body and/or a complexed heavy metal substance produced by using an artificial complexing agent, specifically, such as copper ethylenediaminetetraacetate (Cu-EDTA) or alkyl tin. In the present invention, the organic matter preferably includes a persistent organic matter, heavy-metal-bearing sludge, and/or a non-biodegradable organic matter, and such as, specifically, roxarsone (ROX) or arsanilic acid (p-ASA). In an embodiment of the present invention, specifically, a solution including copper (Cu(II)), cobalt (Co(II)), cadmium (Cd(II)) and lead (Pb(II)) is used as a target inorganic heavy metal substance, and the ROX is used as a target organic heavy metal substance to verify the feasibility of the technical proposal of the present invention.

In the present invention, a molar concentration ratio of the soluble permanganate to the heavy metal in the water body is preferably (1-1,000):1, more preferably (1-100):1, and most preferably (1-50):1.

In the present invention, the wavelength of the light is preferably ≤400 nm, more preferably 0.001-300 nm, and most preferably 0.001-260 nm; the intensity of the light irradiation is preferably 40-1,500 mJ·cm⁻², more preferably 60-1,000 mJ·cm⁻², and most preferably 80-400 mJ·cm⁻².

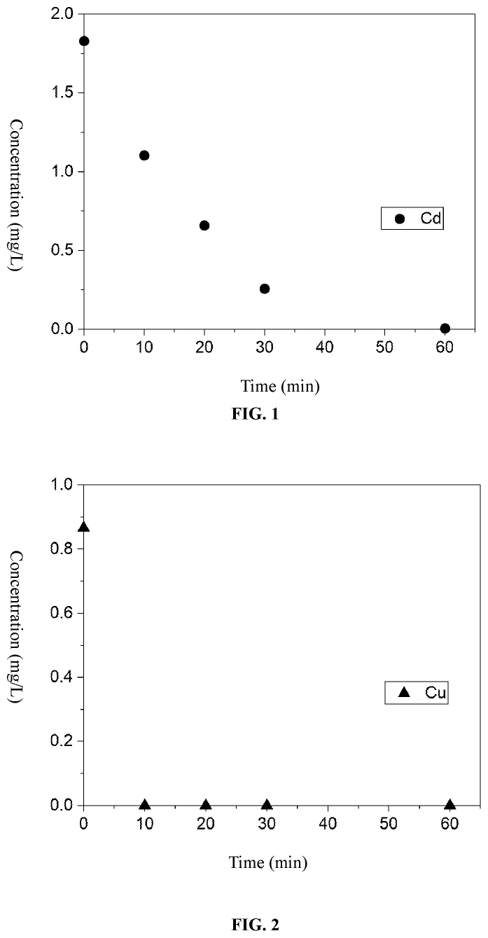

After the water body is diluted with a 2% dilute nitric acid solution, an inductively coupled plasma mass spectrometer ICP-MS (model NexION 350D) is used to measure the content of the heavy metal Cu in the water body during the oxidation-adsorption reaction in Embodiment 2. The measurement results are shown in Table 2. A graph showing a change in the concentration of the heavy metal Cu in the water body with time is obtained according to the measurement results, as shown in FIG. 2.

The present invention has no special limit on the manner of the light irradiation, and an irradiation manner well known to those skilled in the art may be used. In the present invention, the manner of the light irradiation is preferably over-current, immersed or surface irradiation. When the manner of the light irradiation is over-current or immersed, the present invention preferably nests the light source into a quartz tube for protection. The present invention has no special limit on the specific operation of nesting the light source into the quartz tube; specifically, if an ultraviolet lamp tube is used to provide light, the shell of the ultraviolet lamp tube is made of quartz glass.

In the present invention, the temperature of the oxidation-adsorption reaction is preferably 20-40° C., and more preferably 25-35° C. In an embodiment of the present invention, the oxidation-adsorption reaction is specifically performed at room temperature, that is, no additional heating or cooling is required. In the present invention, the time of the oxidation-adsorption reaction is preferably 10-60 min, more preferably 20-60 min, and most preferably 30-60 min.

In the present invention, the initial pH of the oxidation-adsorption reaction is preferably 4-9, more preferably 5-8, and most preferably 6-7. The present invention has no special limit on a pH adjusting reagent, and a reagent well known to those skilled in the art may be used, specifically, such as one or more of nitric acid, hydrochloric acid, sulfuric acid and sodium hydroxide. The present invention has no special limit on the specific concentration of the pH adjusting reagent, and one satisfying the above pH value may be used.

In the present invention, the oxidation-adsorption reaction is preferably performed under a stirring condition; the present invention has no special limit on the rate of the stirring, and a stirring rate well known to those skilled in the art may be used.

The present invention does not require additional addition of other catalysts, but utilizes light to photo-decompose the permanganate to produce an active manganese substance (for example, Mn(V) and Mn(III)), a hydroxyl radical (.OH), and a stable colloidal manganese oxide having rich surface hydroxyl groups and a large specific surface area. These active substances can promote the release of an organic heavy metal into a free heavy metal ion by oxidation; at the same time, they can also promote the adsorption of the colloidal manganese oxide on the free heavy metal ion. Therefore, the technique removes the inorganic heavy metal and organic heavy metals from the water body by the combined action of oxidation and adsorption.

To further describe the present invention, the method for removing a heavy metal from a water body provided by the present invention is described below in detail with reference to embodiments, but the embodiments may not be interpreted as limitations to the protection scope of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

### Embodiment 1

Preparation of a to-be-treated water body: adding 1 mL of cadmium nitrate (Cd(NO₃)₂) with a concentration of 14 mmol/L to 700 mL of ultrapure water, which is 20 μmol/L as the concentration of Cd(II) in the system.

Removal treatment of an inorganic heavy metal Cd: adjusting an initial pH of the to-be-treated water body to 6 with dilute nitric acid and a sodium hydroxide solution, then adding a potassium permanganate solution to the water body, and performing a reaction under light irradiation to remove the inorganic heavy metal, where potassium permanganate has a concentration of 100 μmol/L; the light has a wavelength of 254 nm and an intensity of 2.07 mW·cm⁻², and the manner of the light irradiation is immersed; the heavy metal removal reaction is performed at room temperature 25° C. under a stirring condition, and the time of the oxidation-adsorption reaction is 60 min.

After the water body is diluted with a 2% dilute nitric acid solution, an inductively coupled plasma mass spectrometer ICP-MS (model NexION 350D) is used to measure the content of the heavy metal Cd in the water body during the oxidation-adsorption reaction in Embodiment 1. The measurement results are shown in Table 1. A graph showing a change in the concentration of the heavy metal Cd in the water body with time is obtained according to the measurement results, as shown in FIG. 1.

The removal rate of the cadmium element in the water body is calculated by Formula (I):

removal rate=(C₀−Cₜ)/C₀, Formula (I):

where, C₀ is an initial concentration, and Cₜ is a concentration after a certain period of treatment.

TABLE 1
Measurement results of heavy metal Cd content in the
water body of Embodiment 1

| Treatment time | Concentration (ppm) |
|---|---|
| 0 min | 1.828935694 |
| 10 min | 1.102830254 |
| 20 min | 0.658106652 |
| 30 min | 0.257664292 |
| 60 min | 0.006337826 |

It can be seen from Table 1 and FIG. 1 that, under the experimental conditions described in Embodiment 1, a technical effect is achieved that the removal rate of the cadmium element in the water body reaches 99.65% at 60 min, and the removal of the heavy metal is efficient and rapid.

### Embodiment 2

Preparation of a to-be-treated water body: adding 1 mL of copper nitrate (Cu(NO₃)₂) with a concentration of 14 mmol/L to 700 mL of ultrapure water, so that the concentration of Cu(II) in a system is 20 μmol/L.

Removal treatment of an inorganic heavy metal Cu: adjusting an initial pH of the to-be-treated water body to 6 with dilute nitric acid and a sodium hydroxide solution, then add a potassium permanganate solution to the water body, and performing a reaction under light irradiation to remove the inorganic heavy metal, where potassium permanganate has a concentration of 100 μmol/L; the light has a wavelength of 254 nm and an intensity of 2.07 mW·cm⁻², and the manner of the light irradiation is immersed; the heavy metal removal reaction is performed at room temperature 25° C. under a stirring condition, and the time of the oxidation-adsorption reaction is 60 min.

After the water body is diluted with a 2% dilute nitric acid solution, an inductively coupled plasma mass spectrometer ICP-MS (model NexION 350D) is used to measure the content of the heavy metal Cu in the water body during the oxidation-adsorption reaction in Embodiment 1. The measurement results are shown in Table 2. A graph showing a change in the concentration of the heavy metal Cu in the water body with time is obtained according to the measurement results, as shown in FIG. 2.

The removal rate of the copper element in the water body is calculated by Formula (I):

removal rate=(C₀−Cₜ)/C₀, Formula (I):

where, C₀ is an initial concentration, and Cₜ is a concentration after a certain period of treatment.

TABLE 2
Measurement results of heavy metal Cu content in the water
body of Embodiment 2

| Treatment time | Concentration (ppm) |
|---|---|
| 0 min | 0.866242881 |
| 10 min | 0.0002366 |
| 20 min | 0 |
| 30 min | 0 |
| 60 min | 0 |

It can be seen from Table 2 and FIG. 2 that, under the experimental conditions described in Embodiment 2, a technical effect is achieved that the removal rate of the copper element in the water body reaches 99.97% at 10 min and is below a detection limit of the test instrument at 20 min, and the removal of the heavy metal is efficient and rapid.

### Embodiment 3

Preparation of a to-be-treated water body: adding roxarsone (ROX) to 700 mL of ultrapure water, the concentration of the ROX being 10 μmol/L.

Removal treatment of the organic heavy metal substance ROX: adjusting an initial pH to 7 with dilute nitric acid and a sodium hydroxide solution, then add a potassium permanganate solution to the water body, and performing a reaction under light irradiation to remove the organic heavy metal, where potassium permanganate has a concentration of 100 μmol/L; the light has a wavelength of 254 nm and an intensity of 2.07 mW·cm⁻², and the manner of the light irradiation is immersed; the heavy metal removal reaction is performed at room temperature 25° C. under a stirring condition, and the time of the oxidation-adsorption reaction is 60 min.

A liquid chromatography-inductively coupled plasma mass spectrometer LC-ICP-MS is used to measure the concentration content of an arsenic element in the water body during the oxidation-adsorption reaction in Embodiment 3. The measurement results are shown in Table 3. A graph showing a change in the concentration of the arsenic element in the water body with time is obtained according to the measurement results, as shown in FIG. 3.

The removal rate of the ROX in the water body is calculated by Formula (I): Formula (I): removal rate=(C₀−Cₜ)/C₀, where, C₀ is an initial concentration, and Cₜ is a concentration after a certain period of treatment.

TABLE 3
Measurement results of arsenic element content in the water
body of Embodiment 3 (μg/L)

| Treatment | | |
|---|---|---|
| time | AS (III) | AS (ROX) |
| 0 min | 0 | 750.0000 |
| 10 min | 3.3719 | 154.0998 |
| 20 min | 19.3572 | 73.4443 |
| 30 min | 2.4912 | 54.1447 |
| 60 min | 2.4282 | 25.0392 |

It can be seen from Table 3 and FIG. 3 that, the treatment method provided by the present invention can well oxidize the organic arsenic ROX, and release and adsorb inorganic arsenic; under the experimental conditions described in Embodiment 3, the removal rate of the ROX reaches 96.66% at 60 min of the reaction.

### Embodiment 4

Preparation of a to-be-treated water body: adding ROX to 700 mL of ultrapure water, the concentration of the ROX being 10 μmol/L.

Removal treatment of the organic heavy metal substance ROX: adjusting an initial pH to 5 with dilute nitric acid and a sodium hydroxide solution, then add a potassium permanganate solution to the water body, and performing a reaction under light irradiation to remove the organic heavy metal, where potassium permanganate has a concentration of 50 μmol/L; the light has a wavelength of 254 nm and an intensity of 2.07 mW·cm⁻², and the manner of the light irradiation is immersed; the heavy metal removal reaction is performed at room temperature 25° C. under a stirring condition, and the time of the oxidation-adsorption reaction is 60 min.

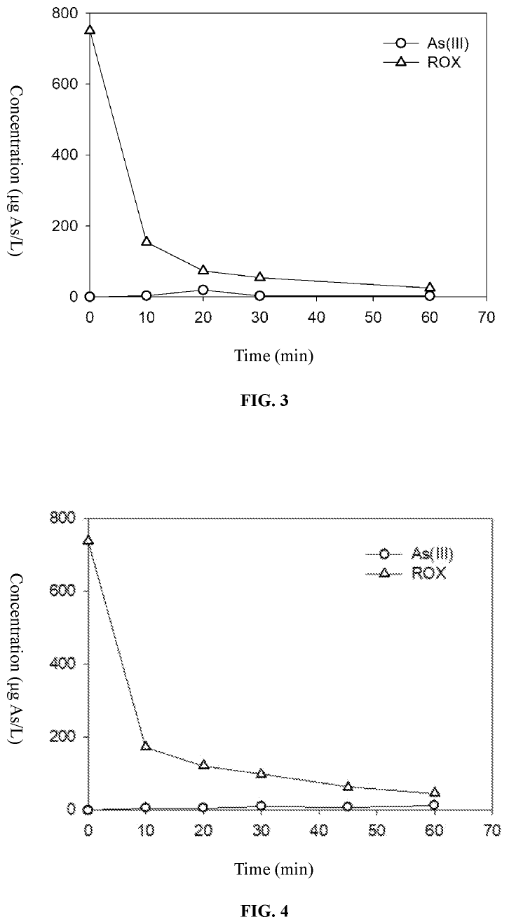

A liquid chromatography-inductively coupled plasma mass spectrometer LC- ICP-MS is used to measure the concentration content of an arsenic element in the water body during the oxidation-adsorption reaction in Embodiment 4. The measurement results are shown in Table 4. A graph showing a change in the concentration of the arsenic element in the water body with time is obtained according to the measurement results, as shown in FIG. 4.

The removal rate of the ROX in the water body is calculated by Formula (I): Formula (I): removal rate=(C₀−Cₜ)/C₀, where, C₀ is an initial concentration, and Cₜ is a concentration after a certain period of treatment.

TABLE 4
Measurement results of arsenic element content in the water
body of Embodiment 4 (μg/L)

| Treatment | | |
|---|---|---|
| time | AS (III) | AS (ROX) |
| 0 min | 0 | 737.1800 |
| 10 min | 5.8810 | 172.8623 |
| 20 min | 5.5285 | 120.1864 |
| 30 min | 10.5696 | 98.4132 |
| 45 min | 8.4207 | 62.9924 |
| 60 min | 12.4779 | 45.7023 |

It can be seen from Table 4 and FIG. 4 that, the treatment method provided by the present invention can well oxidize the organic arsenic ROX, and release and adsorb inorganic arsenic; under the experimental conditions described in Embodiment 4, the removal rate of the ROX reaches 93.80% at 60 min of the reaction.

The above embodiments show that the method provided by the present invention can not only decompose an organic pollutant containing a heavy metal in the water body, but also adsorb and remove a heavy metal ion, thereby realizing the adsorption and removal of the heavy metal ion while solving the problem of decomposition of the organic matter including the heavy metal. The method has high removal efficiency, simple operation, low cost, and no secondary pollution, and can be applied to deep treatment of a water body including a heavy metal, and has significant contribution to environmental protection.

The foregoing descriptions are only preferred implementation manners of the present invention. It should be noted that for a person of ordinary skill in the art, several improvements and modifications may further be made without departing from the principle of the present invention. These improvements and modifications should also be deemed as falling within the protection scope of the present invention.

What is claimed is:

1. A method for removing a heavy metal from a water body, comprising the following steps:
mixing a soluble permanganate with a water body containing heavy metal, and performing an oxidation-adsorption reaction under a light irradiation condition.

2. The method according to claim 1, wherein the soluble permanganate is potassium permanganate and/or sodium permanganate, and the concentration of the soluble permanganate in the water body is 5-1,000 μmol/L.

3. The method according to claim 1, wherein the form of the heavy metal in the water body comprises an inorganic form and/or an organic form; the inorganic form comprises an inorganic salt comprising one or more of copper, cobalt, cadmium, lead, arsenic, thallium, zinc, chromium, selenium and tin; the organic form comprises an organic matter comprising one or more of copper, cobalt, cadmium, lead, arsenic, thallium, zinc, chromium, selenium and tin.

4. The method according to claim 1, wherein a molar concentration ratio of the soluble permanganate to the heavy metal in the water body is (1-1,000):1.

5. The method according to claim 1, wherein the wavelength of the light is ≤400 nm; the intensity of the light irradiation is 40-1,500 mJ·cm⁻².

6. The method according to claim 1, wherein a light source of the light comprises one or more of a light emitting diode, a low pressure mercury lamp, a medium pressure mercury lamp, a high pressure mercury lamp, an amalgam ultraviolet lamp, a halogen lamp, a xenon lamp, a black lamp, a vacuum ultraviolet lamp, an X-ray, an α-ray, and a Υ-ray.

7. The method according to claim 1, wherein the manner of the light irradiation is over-current, immersed or surface irradiation.

8. The method according to claim 1, wherein the temperature of the oxidation-adsorption reaction is 20-40° C., and the time is 10-60 min.

9. The method according to claim 8, wherein an initial pH of the oxidation-adsorption reaction is 4-9.

10. The method according to claim 9, wherein a reagent for adjusting the pH of the oxidation-adsorption reaction is one or more of nitric acid, hydrochloric acid, sulfuric acid and sodium hydroxide.
